(19) United States
(12) Patent Application Publication
(10) Pub. No.: US 2012/0276501 A1
(43) Pub. Date: Nov. 1, 2012

(54) DISPOSABLE OSTEOGENESIS AND OSSEOINTEGRATION PROMOTION AND MAINTENANCE DEVICE FOR ENDOSSEOUS IMPLANTS

(75) Inventors: Hanan Terkel, Ramat Gan (IL); David Madjar, Ramat Gan (IL)

(73) Assignee: Cellectric Medical Ltd., Netanya (IL)

(21) Appl. No.: 12/672,086

(22) PCT Filed: Aug. 5, 2008
(86) PCT No.: PCT/IL08/01070

§ 371 Date: Apr. 13, 2011

Related U.S. Application Data
(63) Continuation-in-part of application No. 10/543,595, filed on May 1, 2006, now Pat. No. 7,917,223.
(60) Provisional application No. 60/954,168, filed on Aug. 6, 2007.

(51) Int. Cl. A61C 19/06; A61C 8/00

(52) U.S. Cl. 433/173

(57) ABSTRACT

A disposable osteogenesis and osseointegration promotion and maintenance device that includes : a dental abutment; a stimulation circuit positioned within a space defined at least partially by the dental abutment; and at least one externally disposed electrode that is spaced apart from a dental implant that is connected to the dental abutment; wherein each electrically disposed electrode is connected to an electrical component selected from a group consisting of a battery and a stimulation circuit

### RELATED APPLICATION

This application claims priority from U.S. provisional patent Ser. No. 60/954168 filing date Aug. 6, 2007.

### FIELD OF THE INVENTION

The present invention relates to the processes of accelerating the integration of endosseous dental implants into its bone surrounding by means of weak currents. In particular, the present invention relates to self-powered devices, attached to a surgically inserted dental implant, the devices used for accelerating bone growth and healing in and around the implant surgical site. By “self-powered” is meant devices that include a built-in power source such as a battery. The following description deals in detail with dental implants.

### BACKGROUND OF THE INVENTION

It is known that dental implants are widely used, and manufactured by a number of companies (e.g. Nobel Biocare USA, Inc., 22715 Savi Ranch Parkway, Yorba Linda, Calif. 92887). Dental implants replace the natural tooth roots as anchors for the restorative device. As such, they must be well integrated into the hard bone tissue. The conventional procedure for inserting a dental implant includes drilling a hole in the maxillary or mandibular jawbone, and inserting the implant in the prepared hole. Various types of endosseous dental implants are used, e.g. blades, screws, and cylinders. The implant is generally made of titanium or titanium alloy and the top of the implant is provided with mating means (usually a top portion and inner threads) for attaching the restorative device. Before attaching the restorative device, however, there is typically a healing phase of between three to six months, during which time bone tissue grows around the implant so that it becomes well integrated with the adjacent bone. This is when direct bone-to-implant interface has been achieved. However, the implant is still at a risk of failure and crestal bone loss within the first year, some of the main reasons being poor bone strength at the interface, and low bone-to-implant contact ratio. The primary goal of osteogenesis and osseointegration as related to implants is to increase bone density and implant-bone contact ratio around any new implant as a routine common clinical practice.

During the initial and primary healing phase, a cover screw is usually attached to the top of the implant to maintain the integrity of the top portion and inner threads of the implant. After the healing phase is completed and bone integration has successfully occurred, the cover screw is removed and discarded and the restorative phase of the treatment can be initiated. In the initial bone-healing phase, woven bone is formed around the implant. This type of bone is only partly mineralized, and therefore less able to withstand the high magnitude forces applied on the implant. The 3-6 month delay between the time of insertion of the implant and the time when a restoration can be made is needed in order for the woven bone to mature and mineralize. The delay is needed because it usually takes this length of time for the bone-forming cells and bone tissue surrounding the implant to mature sufficiently to adequately hold the implant, so that the final restoration will be firmly and properly anchored. This delay is a clear disadvantage of the conventional procedure in use today, leaving the patients with impaired oral function and esthetics because of the missing teeth. The goal of the restorative dentist is to restore normal function and esthetics with no delay, therefore a dual-function device is needed: 1) for osteogenesis and osseointegration promotion to fasten and ensure implantation success and 2) a prosthetic design that allows for immediate tooth restoration. Such a dual-function device is not known in the art. The conventional procedure of inserting a dental implant in extraction sites requires the following time intervals: 3-4 month for site healing; drilling in, inserting the implant in the prepared site and another 3-4 month for implant Osseointegration (after the implant insertion in the maxillary or mandibular jawbone).

During the combined post extraction and post implantation healing periods (of 6-8 months in the conventional cases!!) the patients are forced to wear temporary restorations such as removable dentures. The temporary restorations are relatively expensive, time consuming for patient and doctors and cause aesthetic and functional discomfort.

These drawbacks have forced the market to accept the immediate loading procedures even though they are barely scientifically justified and pose risks to the process of osseointegration. Immediate implant loading is restricted only to cases where the implant is inserted in high quality bone. However, more frequently implants must be placed in areas of deficient bone like post extraction sockets or in poor quality bone. Such problematic implantation sites are further complicated by systemic conditions like diabetes, heavy smoking etc. These limitations require extended osseointegration periods (up to 9-months).

It has long been known that the application of electric currents (electric stimulation) can speed bone growth and healing. The electrical stimulation may employ faradic, inductive or capacitive signals. In the mid-1960s, C. A. L. Bassett and others measured the weak electrical signals generated by the bone itself, analyzed and reproduced those signals artificially, and used them to reverse osteoporosis or aid in the healing of fractured bones. E. Fukuda in “On the piezoelectric effect of bone”, J Physiol. Soc. Jpn. 12:1158-62, 1957, and Yasuda, J. Kyoto Med. Assoc. 4: 395-406, 1953 showed that stress induced on crystalline components of bone produced current flow. Yasuda showed that similar electric signals could enhance fracture healing. Direct current capacitively coupled electric fields and alternately pulsed electro magnetic fields affect bone cell activity in living bone tissue. Friedenberg et al. in “Healing of nonunion by means of direct current”, J. Trauma, 11:883-5, 1971, were the first to report healing of nonunion with exogenous current. Brighton et al, in “Treatment of recalcitrant nonunion with a capacitatively coupled electric field”, J. Bone Joint Surg. Am. 65:577-85, 1985, reported 84% healing of nonunion with D.C. treatment. Time-varying current delivering electrodes have also been used in order to minimize accumulation of electrode products, while square wave patterns were shown to hasten mineralization during bone lengthening in the rabbit tibia. In his study, Brighton used capacitatively coupled electric fields to the limb by capacitor plates over the skin, and accelerated bone fracture healing.

K. S. McLeod and C. T. Rubin in “The effect of low frequency electrical fields on osteogenesis”, J. Bone Joint Surg. 74a:920-929, 1992, used sinusoidal varying fields to stimulate bone remodeling. They found that extremely low frequency sinusoidal electric fields (smaller than 150 Hz) were effective in preventing bone loss and inducing bone formation. They also found strong frequency selectivity in the range of 15-30 Hz. At 15 Hz, induced electric fields of no more then 1 mV/m affected remodeling activity. Fitzsimmons et al. in “Frequency dependence of increased cell proliferation”, J Cell Physiol. 139(3):586-91, 1985, also found a frequency specific increase in osteogenic cell proliferation at 14-16 Hz. Wiesmann et al. in “Electric stimulation influences mineral formation of osteoblast like cells in vitro”, Biochim. Biophys. Acta 1538(1):28-37, 2001 applied an asymmetric saw tooth wave form at 16 Hz and found enhanced bio-mineralization. W. H. Chang in “Enhancement of fracture healing by specific pulsed capacitatively coupled electric field stimulation”, Front. Med. Biol. Eng., 3(1):57-64, 1991, showed similar beneficial results at 15 Hz to those achieved by Brighton with a 60 KHz sine-wave. Other recent references on faradic stimulation include the paper by C. E. Campbell, D. V. Higginbotham and T. K Baranowski published in Med. Eng. Phys., vol. 17, No. 5, pp. 337-346, 1995 (hereinafter CAM 95), and U.S. Pat. No. 5,458,627 to Baranowski and Black. Studies related specifically to dental bone tissue are also known, and a number of patents disclose related systems, for example U.S. Pat. No. 4,244,373 to Nachman. However, the art that relates specifically to dental bone growth stimulation by small, self powered electrical means is very limited.

U.S. Pat. No. 5,292,252 to Nickerson et al. discloses a stimulator healing cap powered by an internal small battery. The cap can be reversibly attached to a dental implant, and stimulates bone growth and tissue healing by application of a direct current path or electromagnetic field in the vicinity of bone tissue surrounding the implant, after the implant is surgically inserted. While Nickerson does not provide details of the battery, it is clear from his description that his battery is volumetrically extremely small, thus having very small capacity, which may not suffice for effective DC stimulation. Moreover, it does not contain a control circuit which is imperative to maintain constant current. It requires an implant which is sub gingival for closing the circuit while some of the implants are at or above the gingival level. Uncontrolled DC stimulation, such as supplied directly from a battery, may have negative side effects. For example, Kronberg in U.S. Pat. No. 6,321,119 points out that studies on electrical stimulation of bone growth have shown that application of DC stimuli alone may be problematic in stimulating bone regeneration since bone grows near the cathode (i.e. the negative electrode), but often dies away near the anode. This phenomenon may result from electrolytic effects, which can cause tissue damage or cell death through pH changes or the dissolution of toxic metals into body fluids. Other disadvantages of Nickerson's device include: being sunken into the gingiva, it has an internal volume too small to contain a large enough battery. The healing cap is connected to the implant by a thin, weak plastic rod that may break during normal chewing. Its insulation section is larger than the battery itself, limiting the size of the battery even more.

Although bone growth stimulation by AC or pulsed currents is deemed beneficial, there are no known practical, self-powered, compact dental stimulator caps using such currents. A somewhat related device disclosed by Sawyer et al. in U.S. Pat. No. 4,027,392 lacks enough description to warrant detailed discussion. Sawyer's disclosure mentions an embodiment of a bionic tooth powered by a battery and including an AC circuit that is clearly impractical: among major disadvantages, it does not appear to be removable without major surgery (since removal of his upper portion 26 occurs by unscrewing insulating member 30 from external implant thread 22, thus causing major trauma to the extensive gingival area contacted by portion 26); it uses a preferred signal frequency range of 0.5 to 1 mHz; and it cannot provide current pulses. The micro-circuitry indicated by its FIG. 3 is not shown incorporated within the cap, and it is extremely doubtful that it can be implemented in the system shown. Its battery cap (“crown”) is too long, penetrating deep into the gingiva (or even through the bone), thus being unfeasible and useless from a surgeon's point of view. Also, Sawyer's device is not a dual-function device, i.e. it does not serve as a temporary abutment on which one can install a temporary crown.

Another related device is disclosed by Dugot in U.S. Pat. No. 5,738,521. Dugot describes a method for accelerating osseointegration of metal bone implants using AC electrical stimulation, with a preferably symmetrical 20 μA rms, 60 KHz alternating current signal powered by a small 1.5 V battery. However, Dugot's system is not a compact, self-powered stimulator cap, but a cumbersome, externally (to the implant) wired and powered stimulator, which does not appear to be feasibly applicable to human dental implants.

Osteogenesis devices for non-dental implants include interbody fusion devices as described in U.S. Pat. No. 6,605,089B1 to Michelson. Michelson describes a self contained implant having a surgically implantable, renewable power supply and related control circuitry for delivering electrical current directly to an implant which is surgically implanted within the intervertebral space between two adjacent vertebrae. Electrical current is delivered directly to the implant and thus directly to the area in which the promotion of bone growth is desired. However, Michelson's apparatus is not an adaptation of a readily available implant, nor does it have an optimal configuration of electrodes.

Other devices are disclosed in U.S. Pat. No. 4,026,304 to Levy, U.S. Pat. No. 4,105,017 to Ryaby, U.S. Pat. Nos. 4,430999, 4,467,808 and 4,549,547 to Brighton, U.S. Pat. No. 4,509520 to Dugot, U.S. Pat. No. 4,549,547 to Kelly and U.S. Pat. No. 5,030,236 to Dean, and in a recent US patent application No 20030040806 by MacDonald.

U.S. Pat. No. 6,034,295 discloses an implantable device with a biocompatible body having at least one interior cavity that communicates through at least one opening with the surroundings of the body so that tissue surrounding the implantable device can grow through the opening; two or more electrodes within the device having terminals for supplying a low-frequency electrical alternating voltage and at least one of which is located inside the cavity. U.S. Pat. No. 5,030,236 also discloses the use of electrical energy that relies upon radio frequency energy coupled inductively into an implanted coil to provide therapeutic energy. U.S. Pat. Nos. 5,383,935, 6,121,172, 6,143,035, 6,120,502, 6,034,295, and 5,030,236 all relate to the use of various materials and forms of energy to enhance the regrowth of bone at the interface between an implant and the native bone. None of these devices perform satisfactory osteogenesis promotion, maintenance or acceleration while leaving the implant member or stem essentially unchanged in appearance and mechanical properties.

U.S. Pat. No. 6,143,036 and U.S. Pat. No. 6,241,049 disclose an implantable device covered with fibrillar wire for augmenting osteointegration of the device.

PCT Patent Application IL2004/000092 published as WO2004/066851 of the inventors discloses osteogenesis and osseointegration promotion and maintenance devices related for dental endosseous implants include an unchanged implant member being the first electrode (cathode), and a the second electrode (anode) being the active abutment and an electrical source preferably attached to the member and operative to provide electrical stimulation signals to endosseous tissue surrounding the implant through the first and second electrodes. The first electrode may be the member itself. The implant is thus electrically functionalized for osteogenesis and osseointgration acceleration. The device is applicable to both non-dental and dental implants. An advantage of an endosseous implant having an insulating surface, portions of which are inlaid with an electrode, is that the osteogenetic and osseointegrative current is distributed along the length of the implant and not concentrated at one location of the implant.

It would be highly advantageous to have, practical, self-powered osteogenesis and osseointegration promotion and maintenance disposable devices for endosseous implants that can perform electrical stimulation using various signals and has higher efficacy in stimulating osteogenesis and osseointegration than known in the art. Preferably, such devices would allow the use of existing implants.

### SUMMARY OF THE INVENTION

According to the present invention there is provided a disposable osteogenesis and osseointegration promotion and maintenance device for dental endosseous implants without any change to the dental implant as described in the claims and depicted in the attached figures.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-1B shows a preferred embodiment of the osteogenesis device of WO2004/066851 of the inventor as implemented in dental implants in (a) isomeric view and (b) cross-section;

FIG. 2A-2B shows another preferred embodiment of the dental osteogenesis device of WO2004/066851 of the inventor in (a) isomeric view and (b) cross-section;

FIG. 3 shows yet another preferred embodiment of the dental osteogenesis device of WO2004/066851 of the inventor in cross-section;

FIG. 4A-4C shows the device of FIG. 1 inserted with its bottom screw section into a dental implant: (a) isomeric view; (b) cross-section; and (c) an active abutment connected to an implant with a single inlaid electrode;

FIG. 5 shows a schematic diagram of a stimulation mechanism comprising a micro-battery connected to an electronic device;

FIG. 6 depicts an embodiment device for a dental implant with one or more electrodes acting as anodes while the unchanged implant acts as cathode;

FIG. 7 depicts an embodiment device for a dental implant with one or more electrodes acting as anodes while the implant has non-conductive surface and two inlaid electrodes act as a cathode;

FIG. 8 depicts an embodiment device for a dental implant with two or more electrodes acting as anodes in the shape of one anode wire and others metal mesh or ribbon or foil while the unchanged implant acts as cathode;

FIG. 9 depicts an embodiment device for a dental implant with a circular mesh or foil with or without micro holes electrodes acting as anodes while the unchanged implant acts as cathode. This configuration acts as an electric stimulating membrane and perform also guided bone regeneration on implant bone deficient site;

FIG. 10 depicts a cross section of the device of FIG. 9;

FIG. 11 depicts an embodiment device for a dental implant with two or more electrodes one acting as anode and the other as cathode on the opposite side of the bone crest while the implant does not act as cathode;

FIG. 12 illustrates a relationship between pull out forces applied on an implanted device versus the current introduced by the implanted element; and

FIG. 13 illustrates a voltage current algorithm for accelerated oseeo integration;

FIG. 14 depicts a full cross section assembly of the osseo integration acceleration device with the native anti-rotation attached to an unchanged dental implant and containing the stimulation mechanism;

FIG. 15 depicts a detailed drawing of the dental abutment, electrode, fixation screw and sealing element with the native anti-rotation that acts also as the insulator; and

FIG. 16 includes a cross section of a removable cover and a top view of the removable cover.

### DESCRIPTION OF THE PREFERRED EMBODIMENTS

The present invention discloses, in various embodiments, a disposable osteogenesis and osseointegration acceleration device (hereinafter “osseointegration device”) for endosseous dental implants, capable of providing DC, AC and arbitrary current train pulses, or any combination thereof. In a preferred embodiment in which the osteogenesis device is self-powered, the device preferably uses as power source an internal battery. Alternatively, the osseointegration device can be powered remotely from outside the body. Any internal power source relevant to the present invention will hereafter be referred to as a “microbattery”, while the microcircuit that controls output signals will be referred to as a “stimulation circuit or device”. A power source plus stimulation device will be referred to as “stimulation mechanism”. For the sake of simplicity, the term “microbattery” will be applied hereinbelow also to regular batteries.

Although the embodiments of the present invention depicted in various figures relate only to the field of dental implants, it is understood that one skilled in the art is able, upon perusal of the description herein, to apply the teachings of the present invention to non-dental fields. The principles and uses of the teachings of the present invention may be better understood with reference to the accompanying description, figures and examples. In the figures, like reference numerals refer to like parts throughout.

Before explaining at least one embodiment of the invention in detail, it is to be understood that the invention is not limited in its application to the details set forth herein. The invention can be implemented with other embodiments and can be practiced or carried out in various ways. It is also understood that the phraseology and terminology employed herein is for descriptive purpose and should not be regarded as limiting.

Generally, the nomenclature used herein and the laboratory procedures utilized in the present invention include techniques from the fields of biology, chemistry, engineering, material sciences and physics. Such techniques are thoroughly explained in the literature.

Unless otherwise defined, all technical and scientific terms used herein have the same meaning as commonly understood by one of ordinary skill in the art to which the invention belongs. In addition, the descriptions, materials, methods, and examples are illustrative only and not intended to be limiting. Methods and materials similar or equivalent to those described herein can be used in the practice or testing of the present invention.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

As used herein, “a” or “an” mean “at least one” or “one or more”. The use of the phrase “one or more” herein does not alter this intended meaning of “a” or “an”.

The term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Implementation of the methods of the present invention involves performing or completing selected tasks or steps manually, automatically, or a combination thereof.

The term “externally disposed electrode” refers to a conductive element that has a substantial portion located outside a dental abutment. It can be spaced apart from the implant and from both the implant and the dental abutment. It can pass through an opening, aperture, tunnel formed within the dental abutment or prosthesis and it can be connected (for example—by welding) to a conductive portion of the dental abutment.

A osteogenesis and osseointegration promotion and maintenance device is provided. It includes: a dental abutment (that can include a conductive portion, can be a metallic shell); an insulating native anti rotation element; a stimulation mechanism positioned within a space defined at least partially by the dental abutment; and at least one externally disposed electrode that is spaced apart from the dental abutment. Each electrically disposed electrode is connected to an electrical component that can be a battery or a stimulation mechanism.

It is noted that according to another embodiment of the invention the externally disposed electrode is connected (for example—spot welded) to the dental abutment. This externally disposed electrode can be a counter electrode to a electrode that is an unchanged implant or connected to or integrated with the implant.

Conveniently, at least one externally disposed electrode protrudes from the dental abutment.

Conveniently, at least one externally disposed electrode protrudes from the abutment at a sub-gingival portion of the dental abutment.

Conveniently, an externally disposed electrode is shaped so that when the device is implanted in osseous tissue the externally disposed electrode extends under the alveolar mucosa/gingivea.

Conveniently, an externally disposed electrode is insulated from an outer surface of dental abutment portion from which it protrudes.

Conveniently, an externally disposed electrode is shaped as a mesh.

Conveniently, an externally disposed electrode is shaped as a mesh that at least partially surrounds an upper portion of the implant.

Conveniently, the at least one externally disposed electrode is shaped so to provide an evenly distributed current through a tissue that surrounds the implant.

Conveniently, an externally disposed electrode is placed, when the device is implanted, so as to cover a bony deficiency adjacent to the implant site.

Conveniently, an externally disposed electrode is placed, when the device is implanted, so as to contact a bony deficiency adjacent to the implant site.

Conveniently, an externally disposed electrode has shape of a grid or a mesh, the externally disposed electrode is placed, when the device in implanted, so as to contact a bony deficiency adjacent to the implant site.

Conveniently, an externally disposed electrode has shape of a grid or a mesh, the externally disposed electrode is placed, when the device in implanted, so as to contact a bony deficiency adjacent to the implant site and to sub-gingivally extend along a bony crest outer surface.

Conveniently, an externally disposed electrode has a shape selected form the group consisting of a sheet, a foil, a mesh, a net, a strip, a grid, a ribbon, an umbrella, a tissue, a screen, a fabric, a woven fabric and netting.

Conveniently, an externally disposed electrode provides a structural support for directing growth of bone tissue and has a shape selected form the group consisting of a sheet, a foil, a mesh, a net, a strip, a grid, a ribbon, an umbrella, a tissue, a screen, a fabric, a woven fabric and netting.

Conveniently, the at least one externally disposed electrode comprises an externally disposed anode and an externally disposed cathode .

Conveniently, at least one portion of the implant that is coupled to a conductive securing element of the dental abutment acts as an electrode.

Conveniently, at least one portion of the implant that is coupled to a conductive securing element of the dental abutment acts as an electrode.

Conveniently, at least one portion of the implant acts as a counter electrode to an externally disposed electrode.

Conveniently, a conductive securing element of the dental abutment that is connected to the implant acts as a counter electrode to an externally disposed electrode and wherein the conductive securing element is electrically connected to conductive elements that pass trough the implant.

Conveniently, a conductive securing element of the dental abutment that is connected to the implant acts as a counter electrode to an externally disposed electrode and wherein the conductive securing element is electrically connected to at least one ring shaped conductor located at an outer surface of the implant.

Conveniently, the device comprises an internal electrode that is connected between an electrical element within the space at least partially defined by the dental abutment and between a conductive element that contacts a tissue that surrounds the implant and acts as a counter electrode to an externally disposed electrode. Conveniently, a conductive securing element of the dental abutment that is connected to the implant acts as a counter electrode to an externally disposed electrode and wherein the conductive securing element is electrically connected to at least one ring shaped conductor located at an outer surface of the implant.

Conveniently, the device includes multiple externally disposed electrodes, wherein a shape of one externally disposed electrode differs from a shape of another externally disposed electrode.

Conveniently, the device includes a replaceable battery; wherein the dental abutment is shaped to enable a replacement of the replaceable battery. It can have a removable top portion, can have a top portion that can be moved or rotated in relation to other portions of the dental abutment, can have a top portion that is attached by a non-conductive screw (or otherwise detachably connected to other portions of the dental abutment). It is noted that the

Conveniently, the device includes a replaceable battery; wherein the dental abutment comprises a movable portion that when placed at a first position enables a replacement of the replaceable battery.

Conveniently, the stimulation circuit generates an electrical signal selected from the group consisting of Dc currents, AC currents, pulsed, currents, alternating voltages, pulsed voltages.

Conveniently, the stimulation circuit generates an electrical signal that maintains a potential between an externally disposed electrode and a counter electrode below 1.9 volts.

Conveniently, the stimulation circuit generates an electrical signal that maintains a potential between an externally disposed electrode and a counter electrode below 1.2 volts.

Conveniently, the stimulation circuit generates an electrical signal that maintains a potential between an externally disposed electrode and a counter electrode below 1 volt.

Conveniently, the stimulation circuit generates an electrical signal that maintains a potential between an externally disposed electrode and a counter electrode below 0.8 volts.

Conveniently, the stimulation circuit generates an electrical signal that maintains a potential between an externally disposed electrode and a counter electrode below a potential level in which significant electrolysis of fluid at a vicinity of the implant occurs.

Conveniently, the stimulation circuit generates an electrical signal that maintains a potential between an externally disposed electrode and a counter electrode below a potential level in which electrolysis of fluid at a vicinity of the implant occurs.

Conveniently, the stimulation circuit generates an alternating electrical signal that has a cycle that substantially eliminates an increase of resistance in tissue that is proximate to the implant.

Conveniently, the stimulation circuit generates an alternating electrical signal that has a cycle that substantially decreases a resistance in tissue that is proximate to the implant.

Conveniently, the stimulation circuit generates an electrical signal that alternates between a “on” value and an “off” value at a cycle that eliminates an increment of electrolysis of fluid at a vicinity of the implant.

Conveniently, the stimulation circuit generates an electrical signal is an alternating current having a frequency of between about 1 Hz and 100 KHz.

Conveniently, the stimulation circuit generates an electrical signal is an alternating current having a frequency of between about 5 Hz and 50 Hz.

Conveniently, the stimulation circuit generates an electrical signal is an alternating current having a frequency of between about 10 and 20 Hz.

Conveniently, at least a portion of an outer surface of the dental abutment is electrically conductive and in electrical contact with an externally disposed electrode.

Conveniently, at least a portion of a surface of the dental abutment is electrically insulated form an externally disposed electrode.

Conveniently, an externally disposed electrode is elongated.

Conveniently, an externally disposed electrode has a shape selected form the group consisting of wire, ribbon and coil.

Conveniently, an externally disposed electrode is flexible.

Conveniently, an externally disposed electrode is perforated.

Conveniently, an externally disposed electrode comprises a stem part emerging from said abutment.

Conveniently, an externally disposed electrode comprises a stem part emerging from said abutment wherein an outer portion of the stem part is externally insulated.

Conveniently, an externally disposed electrode comprises a stem part emerging from said abutment wherein the stem part comprises an insulation-coated wire.

Conveniently, an externally disposed electrode is about 1 mm long.

Conveniently, an externally disposed electrode is about 2 mm long.

Conveniently, an externally disposed electrode is about 3 mm long.

Conveniently, an externally disposed electrode is about 4 mm long.

Conveniently, an upper body of dental abutment has a shape selected from the group consisting of a cylindrical, conical and angular.

A method of treatment is provided. It includes deploying any of the mentioned above devices.

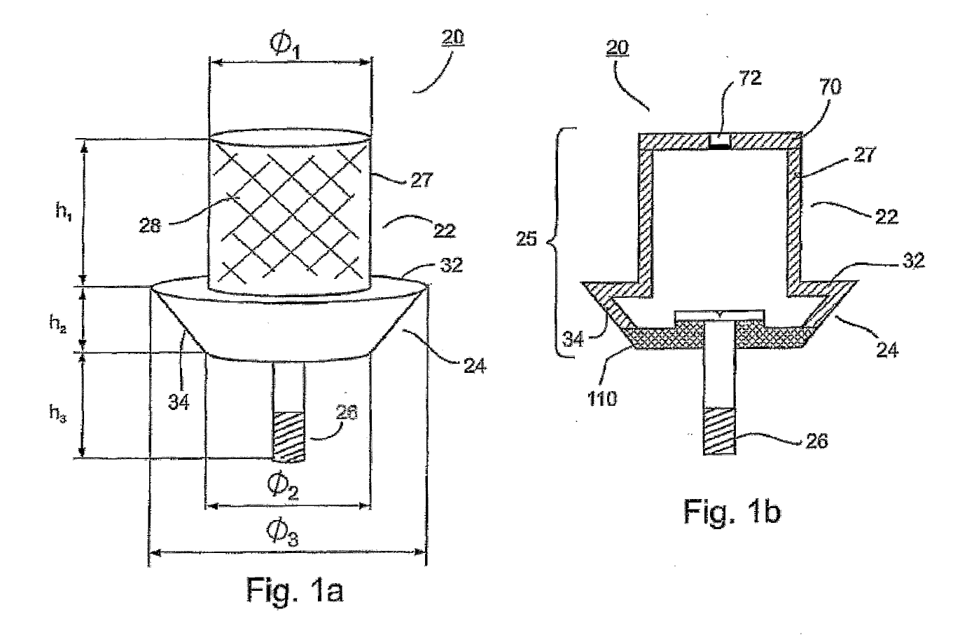

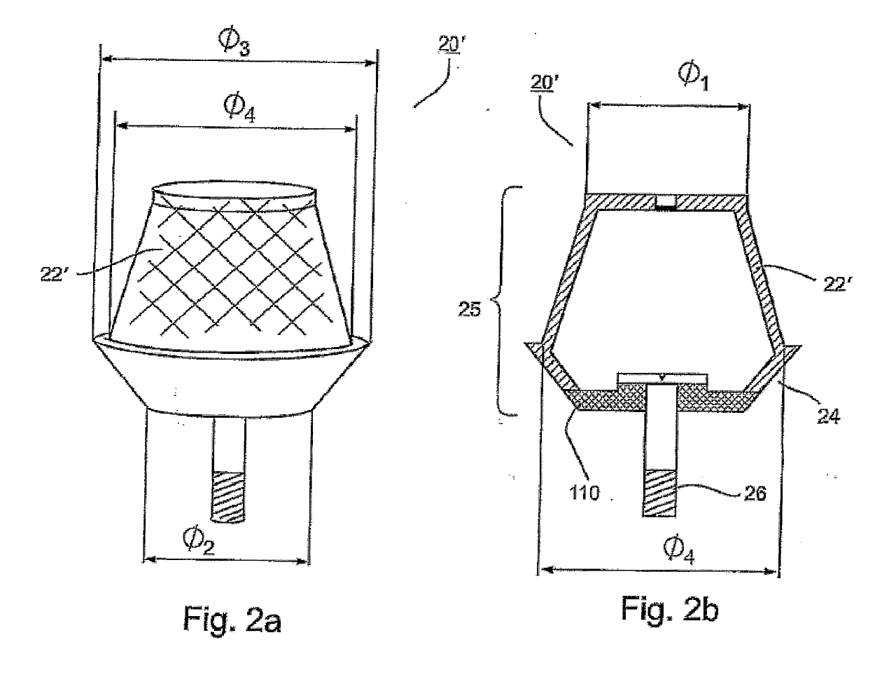

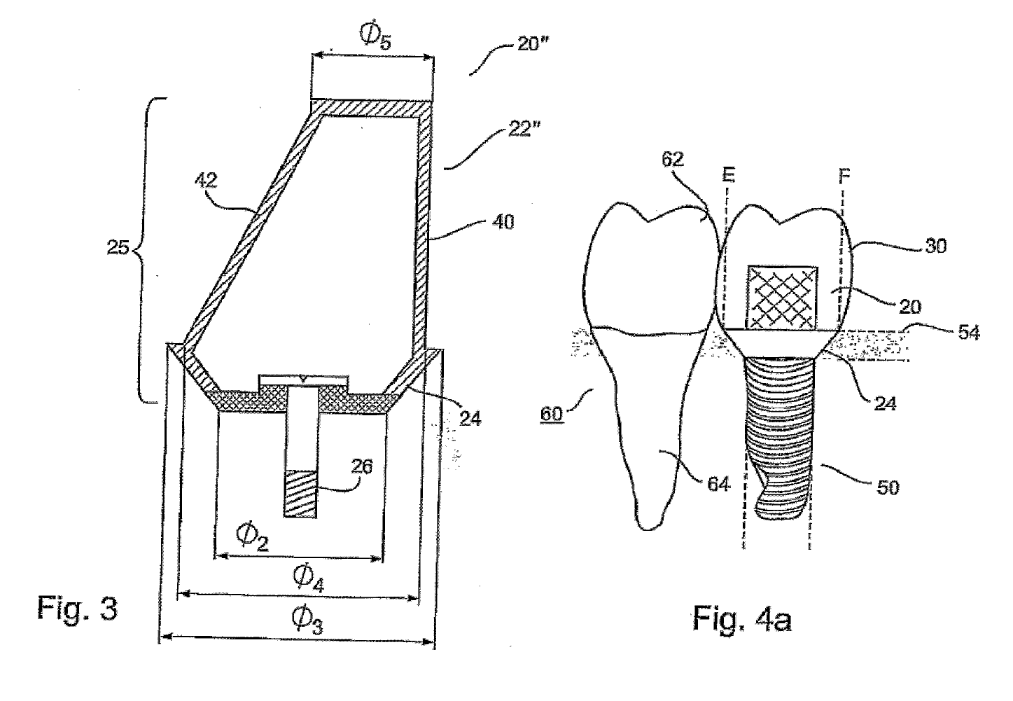

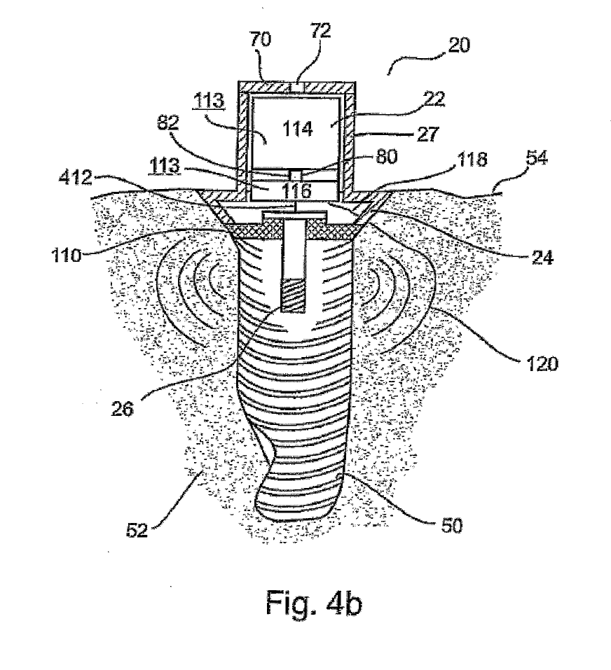

Referring now to the drawings, FIG. 1 shows a preferred embodiment of the osteogenesis device of WO2004/066851 of the inventor, as applied to dental implants. FIG. 1 shows an isometric view of a temporary osteogenesis abutment 20 in (a) and a cross-section in (b). Temporary abutment 20 includes a top section 22, a mid-section 24 and a bottom screw section 26. In a preferred embodiment, sections 22 and 24 are made of one piece, and referred to as an “enclosure” 25 section of the abutment. Top section 22 is preferably cylindrical and internally hollow, with a height h₁ between ca. 3-12 mm, preferably between 3-8 mm, and most preferably around 5 mm; a diameter φ₁ of between 2.5 and 6 mm, preferably between 3.5 and 4.5 mm, and most preferably around 3.75 mm. Top section 22 has a cylindrical envelope wall 27, the same wall extending to mid-section 24 in case the two sections are integrated. For the purposes of WO2004/066851 of the inventor, the optimal thickness of wall 27 is the smallest thickness still ensuring mechanical stiffness and integrity of the abutment, while bonded to a temporary crown, see FIG. 2 and description below. Typically, this thickness is about 0.5-1 mm. Height h₁ depends on the height of the individual tooth to be attached to abutment 20, see below. Top section 22 is preferably made of a metal used normally in present dental abutments, for example titanium, and has an external cylindrical surface 28 prepared or treated to bond to a temporary crown 30 as shown in FIG. 4a. However, section 22 may be made of other materials, such as ceramics or hard plastics, as long as it fulfills the mechanical requirements. Mid-section 24 is structured to ensure at its top plane 32 a perfect match to temporary crown 30, while its side envelope 34 is shaped to allow easy removal upon completion of function. As shown, envelope 34 is preferably conical. Section 24 may be substantially hollow internally and, as pointed out above, may integrally form an “enclosure” of one piece with top section 22, as seen in FIG. 1(a), as well as in FIGS. 2 and 3. Mid-section 24 is made of an electrically conductive rigid material, preferably a metal such as titanium. If integrated with top section 22, the top section is made preferably of the same material, and its wall must be electrically conductive in a contact area with the gingiva, see FIG. 4. Typical dimensions of envelope 34 are a small diameter φ₂ (that presents an emerging profile of the abutment from the gums) of between 3.25 to 6 mm, and most typically around 3.75 mm, a large diameter φ₃ matching the diameter of typical dental implants, currently between 5 and 6 mm, and a height h₂ of typically between 1-4 mm. Mid-section 24 is partially or fully immersed in the gum (gingiva), see FIG. 4, while top section 22 is essentially located on top of the gingiva.

Bottom screw section 26 is metallic, normally made of titanium, and essentially identical with screws typically used to attach existing abutments to dental implants, such as an implant 50 shown in FIG. 4. Screw section 26 is electrically isolated from enclosure 25 by an electrical insulating separator 110, preferably in the shape of a disc.

FIG. 2 shows in isomeric view in (a) and in cross-section in (b) another embodiment of a temporary abutment 20′ according to WO2004/066851 of the inventor. Abutment 20′ is essentially identical in all with abutment 20 of FIG. 1, except for a conical top section 22′ replacing cylindrical top section 20. Conical top section 22′ provides more internal volume to contain the stimulation mechanism, control means and activation means described below. Section 22′ is typically of a small diameter and a height similar to those of section 22 above, while having a large diameter φ₄ close to, and no larger than φ₃.

FIG. 3 shows (in cross section only) an embodiment of a temporary abutment 20″ according to WO2004/066851 of the inventor wherein a top section 22″ is of a combined cylindrical-conical shape, to be referred to hereafter as “angular”. An angular shape is of particular importance for abutments in anterior teeth, and for abutments in anterior and posterior jaw areas because of the angulations of the teeth in the bone. The angulated abutments allow for treatment of angulated implants—a clinical situation often encountered in the maxilla (upper jaw). As made clear by the figure, top section 22″ has a cylindrical envelope section 40 smoothly translating into a conical envelope section 42. A top small diameter φ₅ is now typically smaller than φ₁ while all other dimensions are essentially similar to those in FIGS. 1 and 2. The dental implant embodiment of the invention is now further described based on the embodiment of FIG. 1, with the understanding that the following description applies equally well to the embodiments of FIGS. 2 and 3.

FIG. 4 shows the abutment 20 of FIG. 1 inserted with its bottom screw 26 into dental implant 50, and its top section 22 attached to a temporary crown 30. The figure shows an isomeric view in (a) and a cross-section (without a crown) in (b). FIG. 4(a) also shows an adjacent tooth 60 with a crown 62 and a root 64. In contrast with previous devices, in particular those of U.S. Pat. Nos. 4,027,392 and 5,292,252, the device of WO2004/066851 of the inventor is not only a stimulation device but also a temporary crown-carrying abutment. Moreover, abutment 20 is designed to resemble as much as possible existing abutments, thus not requiring any changes in normal dental surgery procedures, while temporary crown 30 can be individually shaped for each patient. The latter is a critical requirement for such a dual-function device, and a feature that is non-existent in any of the prior art patents. Since the dual-function device (temporary abutment) of WO2004/066851 of the inventor typically resembles existing abutments, its removal and replacement with a permanent crown requires advantageously a standard surgical procedure, unlike special surgical procedures needed in prior art devices.

FIG. 4(b) shows in cross section abutment 20 attached to dental implant 50 implanted in an osseous tissue 52 below gingiva 54. The figure shows the typical positioning of mid-section 24 relative to the top of a gingiva 54. Abutment 20 may in some cases stick out upwards from gingiva 54. However, in all cases, mid-section 24 maintains electrical contact with the gingival tissue.

Implant 50 is preferably a standard metal (preferably titanium) electrically conductive implant manufactured by a number of manufacturers and well known in the art. The figure shows the internal structure inside top section 22 and mid section 24, which is mechanically coupled to implant 50 through screw section 26, while electrically insulated from implant 50 by electrically insulating separator 110. In a preferred embodiment, electrically insulating separator 110 is titanium oxide. Top section 22 may optionally have a removable top plate 70 attached (e.g. screwed in) to cylindrical wall 27, and a socket 72 that may aid in opening the top plate, or removing the entire abutment from implant 50. Separator 110 is preferably of a minimal shape and size that ensure electrical isolation between screw 26 and implant 50 and sections 22 and 24, while imparting mechanical strength to the abutment-implant connection. Separator 110 may be made of any insulating biocompatible material, for example plastic such as Teflon, ceramic, glass, hard rubber, etc. The essential requirement is that mid-section 24 be at least partially in electrical contact with gingiva 54, while electrically isolated from implant 50. Separator 110 is bonded to mid-section 24 and screw 26 in a way that provides both complete sealing between the internal space inside the abutment and the outside, as well as a strong enough mechanical hold for screw 26. Such bonding and sealing may be provided by means including a ceramic seal, a metal-glass seal or a glass-epoxy seal, which are well known in the art.

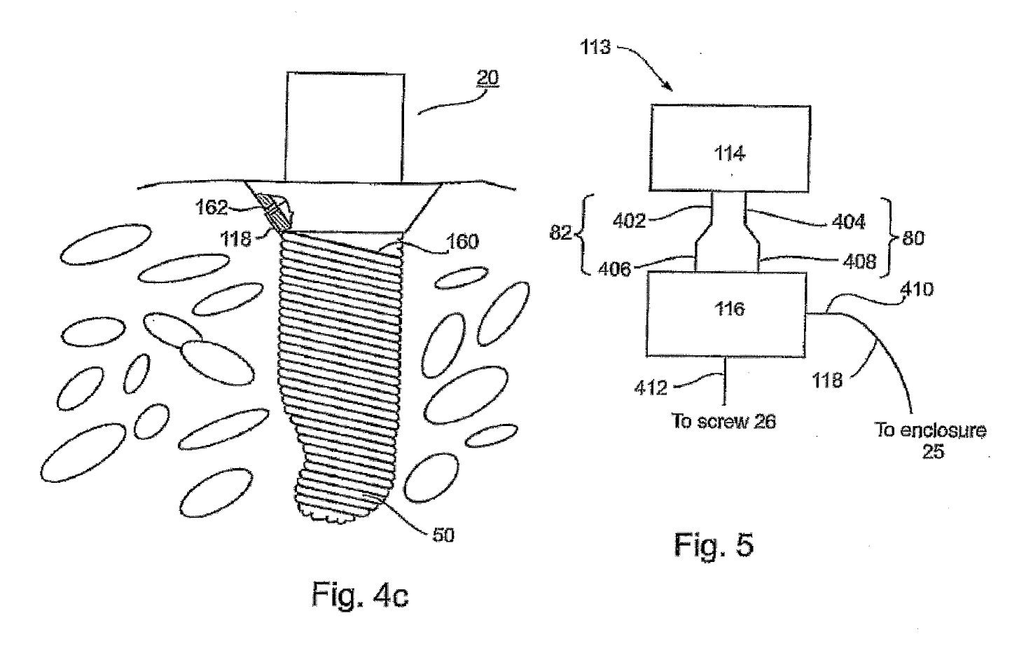

As mentioned, top section 22 as well as (at least partially) mid-section 24 (i.e. enclosure 25) are internally hollow, allowing inclusion of an electrical stimulation mechanism 113 comprised of an internal micro-battery 114 and at least one electronic device 116. Using typical dimensions of φ₁=3.75 mm and wall thickness of 0.5 mm (i.e. the internal diameter of top section 22 is ca. 2.75 mm) and h₁=8 mm, the internal volume of section 22 is about 40-45 mm³. With h₁=5 mm, the volume would be around 25-28 mm³. Section 22′ in FIG. 2 has a larger internal volume. Micro-battery 114 may be a small standard type battery, preferably a Lithium battery, or a thin film battery. As described in more detail in FIG. 5 below, in one embodiment, micro-battery 114 is electrically connected with both polarities to device 116 through electrical contacts 80 and 82. Device 116 is connected with one polarity through a contact 118 to the electrically conductive envelope of enclosure 25, and with another polarity, through screw 26 to implant 50. In another embodiment (not shown), micro-battery 114 may be connected with one polarity to device 116, and with another polarity to either enclosure 25 or screw 26, in which case, device 116 is connected with the other polarity to screw 26 or enclosure 25 respectively. In either embodiment, an electrical path 120 is thus established between mid-section 24 and implant 50 through the tissue composed of gingiva 54 and osseous tissue 52. Electrical path 120 is active (passing current) when micro-battery 114 is connected in the circuit comprising abutment 20, implant 50, osseous tissue 52 and gingiva 54. Path 120 is inactive (no current) when source 114 is disconnected from the circuit, preferably as a result of inputs received through device 116. One task of device 116 is to convert the DC power of micro-battery 114 into AC or pulsed voltages or currents. Another task of device 116 is to provide timing for current pulses. Yet another, optional task of electronic device 116 is to relay and perform instructions from a source external to abutment 20, to activate and de-activate path 120. Device 116 includes most preferably at least one integrated circuit acting as a stimulation circuit, and additionally and optionally as a timing/control circuit, operative to fulfill the tasks listed above, as described in more detail below.

As mentioned above, the electrical stimulation provided by device 20 through at least one electronic device 116 is preferably in the form of AC currents or pulsed DC currents. It should be apparent that any configuration of AC or DC currents may be used alone or in combination, and switching may occur between the types of current used. The conversion of direct current signals, normally provided by a constant power source in the form of a battery or a micro-electro-chemical cell, to AC or pulsed DC signals is well known in the art. In particular, various electrical circuits that perform DC to AC conversion, or generate pulses from a DC voltage or DC current source are known. Such circuits include various signal generators and waveform shaping circuits described for example in chapter 12 of “Microelectronics Circuits” by A. D. Sedra and K. S. Smith, ISBN 0-03-051648-X, 1991, pp. 841-902. Implementation of such circuits (and particularly of oscillator circuits) in integrated (IC) form is also known, for example in U.S. Pat. No. 6,249,191 to Forbes. Low voltage IC circuit architectures suitable for the purposes of WO2004/066851 of the inventor include for example the LM3903 1.3V oscillator by National Semiconductor, described in Application Note 154 (AN-154) of the same company. Notice is taken that successful implementation of a combination of a micro-battery and a DC-to-AC converter or pulse generator circuit in a limited space such as the volume inside enclosure 25 has not been accomplished in prior art, and there are no known products or even prototypes of such combinations. For example, the osteogenesis promoting pulse generator disclosed in U.S. Pat. No. 5,217,009 to Kroneberg is not integrated on a chip, but mounted on a circuit board of relatively large (2.5×5.0 cm) dimensions, the final size requiring a volume of 1.7×2.5×9.5 cm³. Thus prior art pulse generators are of no use for the purposes of WO2004/066851 of the inventor.

The technical requirements of a stimulation device such as electronic device 116 as relating to dental implants are preferably the following: the, device should supply a voltage in the range of 1 micro-Volt to 10 Volt, and most preferably between 100 μV to 5V, with a frequency in the range of 1 Hz to 100 KHz, preferably in the range of 5 Hz to 50 Hz, and most preferably between 10 to 20 Hz; these voltages will supply an AC output current with an amplitude between 1-300 μA. For a pulsed signal, the signal should be at a voltage in the general range above. Pulse burst patterns that may be effective for the purposes of WO2004/066851 of the inventor are characterized for example by waveforms described in FIGS. 1,2, 7 and 9 of U.S. Pat. No. 6,321,119 to Kronberg. For example, in FIG. 1 therein, pulse bursts are characterized by intervals 14 (representing peak voltage or current amplitude), and intervals 16 (“off”), and 18 (“on”), representing the timing between specific transitions. In WO2004/066851 of the inventor, pulse bursts preferably range from continuous to patterns with “on” intervals of between 1-10 msec and preferably 5 msec, and “off” intervals of between 100 to 4000 msec, and preferably between 500 to 2000 msec. These patterns can be defined then in terms of an average frequency of between ca. 15-600 Hz, and preferably between 30-120 Hz. The low preferred frequencies disclosed herein for both AC and pulsed signals are in marked contrast with the orders of magnitude higher frequencies used in prior art stimulation systems.

FIG. 5 shows in more detail a schematic diagram of stimulation mechanism 113 of FIG. 4 comprising micro-battery 114 connected to electronic device 116. Micro-battery 114 includes two terminals of opposite polarities 402 and 404. Electronic device 116 includes two electrical input ports 406 and 408, and two electrical output ports 410 and 412. These output ports (410 and 412) can be regarded as a positive output port and a negative output port of stimulation mechanism 113 and are denoted in various figures as “+” and “−” accordingly. Input ports 406 and 408 are electrically connected to terminals 402 and 404, while output ports 410 and 412 are electrically connected respectively to wall 27 of enclosure 25 through contact 118 and to screw 26. Thus, in contrast with prior art internal batteries used for stimulation in implants, e.g. those of U.S. Pat. Nos. 4,027,392 and 5,292,252, battery 114 may not need to be in direct electrical contact with any part of enclosure 25 or implant 50. A key requirement of means 113 is that it completely reside inside enclosure 25. Therefore, micro-battery 114 has dimensions smaller than the internal dimensions of enclosure 25. In particular, if micro-battery 114 is a conventional battery, preferably a Lithium battery of cylindrical shape, its cylinder diameter has to be no larger than the internal diameter of the enclosure, while its height has to be sufficiently smaller than the internal enclosure height to leave space for device 116. In a preferred embodiment, battery 114 and device 116 are positioned as shown in FIG. 4, i.e. with the battery on top. However, an inverse positioning (battery 114 below device 116) as well as same plane positioning (side-by-side) of the two elements is also possible, and within the scope of WO2004/066851 of the inventor. It is noted that a larger (not a micro-battery) battery can be used. It can be a replaceable battery that is replaced once it is drained.

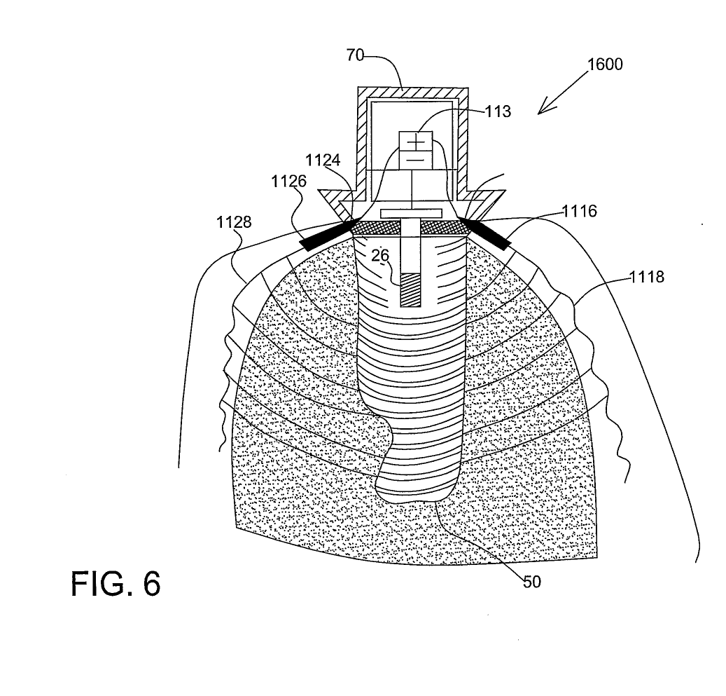

FIG. 6 illustrates device 1600 and its vicinity (various tissues such as bone 52 and gingivae 54). Device 1600 includes abutment 70 having a fixation screw 26 that mates with the implant 50 (which is implanted in the jaw bone) as a cathode and two externally disposed electrodes 1118 and 1128 that are spaced apart from abutment 70 and interposed between gingival 54 and osseous tissue 52.

Each of these externally disposed electrodes protrudes from the dental abutment 70. These electrodes can be flexible, made of platinum or titanium or other metals that protrude from a non-electrode abutment casing top section as anodes and are implanted between the gingivae and bone;

These externally disposed electrodes can act as anodes or cathodes, whereas one externally disposed electrode can act as an anode and another as a cathode. In FIG. 6 both externally disposed electrodes 1118 and 1128 act as anodes while the implant 50 acts as a cathode. FIG. 6 also illustrates insulator such as insulating sleeves 1116 and 1126 through which electrodes both externally disposed electrodes 1118 and 1128 extend. These sleeves surround the upper portions of each electrodes and insulate these electrodes and can seal the openings in dental abutment 70 through which these electrodes extend.

In FIG. 6 both externally disposed electrodes 1118 and 1128 are connected to one output port (such as output port 410 of FIG. 5) of stimulation mechanism 113 while fixation screw 26 is connected, via another output port (such as output port 410 of FIG. 5) of stimulation mechanism 113. The former output port is denoted “+” while the latter is denoted “−”.

FIG. 6 also illustrates (by curved lines) the current that flows between implant 50 and externally disposed electrodes 1118 and 1128.

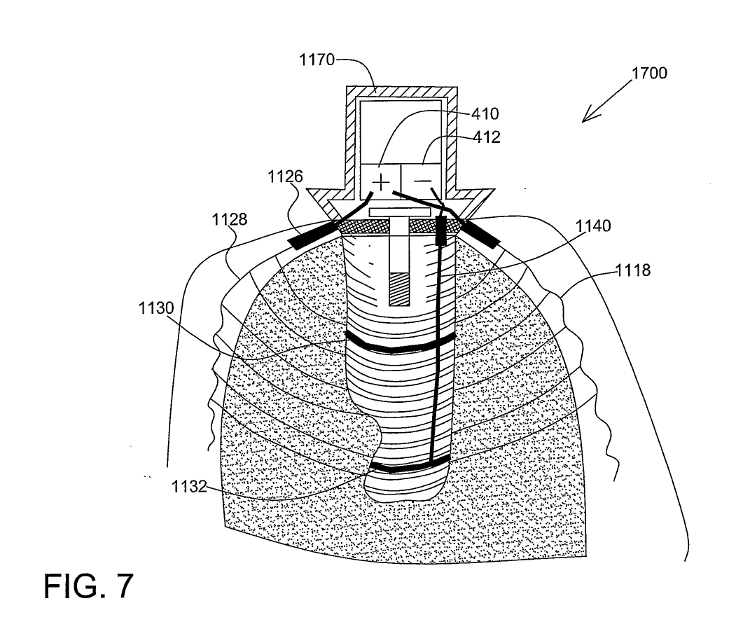

FIG. 7 depicts device 1700 according to an embodiment of the invention.

Implant 50 includes two ring shaped gold conductors 1130 and 1132 inlaid in an otherwise insulating titanium oxide surface as taught in PCT Patent Application IL2004/000092 provided with an abutment 70 of the present invention having a fixation screw 26. An internal electrode 1140 is connected to output port 412 (“−”) of stimulation mechanism 113 while externally disposed electrodes 1128 and 1118 are connected to output port 410 (“+”) of stimulation mechanism 113. It is noted that at least one connection can be routed via stimulation circuit that can, for example, provide an alternating current (AC) current.

It is noted that two ring shaped gold conductors 1130 and 1132 can, alternatively, connected to fixation screw 26, in addition or instead of being connected to an inner electrode.

Both externally disposed electrodes 1118 and 1128 are implanted between the gums and bone.

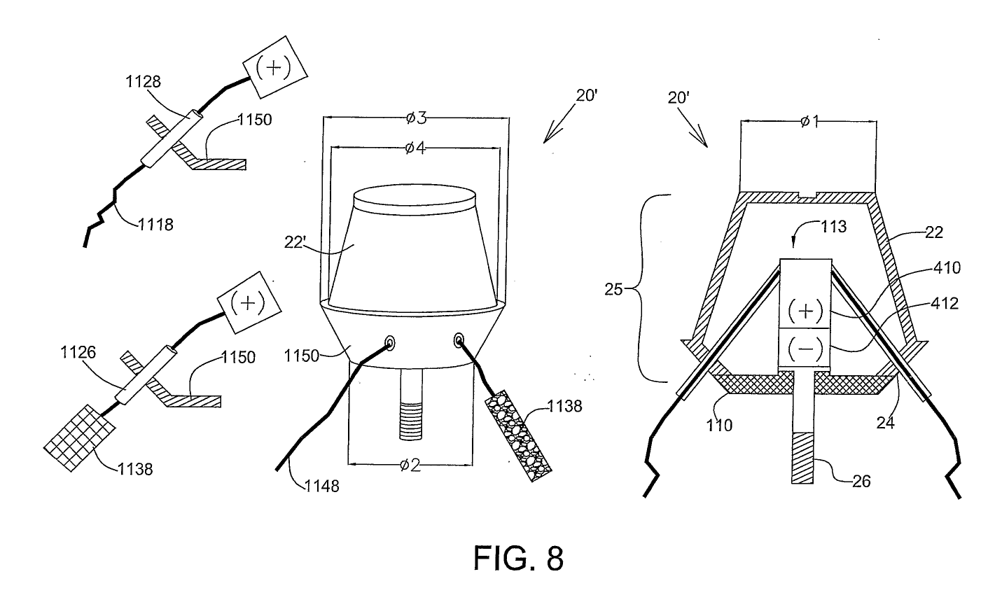

FIG. 8 depicts an abutment 22′ of the present invention having a fixation screw 26 configured to mate with an implant as a cathode, a non-electrode abutment casing top section 22′ and two electrodes 1138 and 1148, 1148 made of titanium, Platinum or other metal wire, 1138 made of titanium, Platinum or other metal mesh , as anodes protruding therefrom. It is noted that the fixation screw can be prevented from receiving an electrical signal and that one externally disposed electrode can act as a cathode while the other can act as an anode. FIG. 8 also provide a cross sectional view of a wall 1150 of a midsection 1150 of abutment 20′, an insulating and sealing sleeve 1128 that passes through an opening is the wall, and externally disposed electrode 1118. Electrodes 1138 and 1148 are connected to output port 410 (“+”) of stimulation mechanism 113.

Each of FIGS. 6, 7, 8, 10 and 11 illustrates two externally disposed electrodes (for example—1118 and 1128, 1170 and 1172, 1138 and 1148, as well as 1180 and 1182) that protrude from the abutment at its sub-gingival part and extend buccally and lingually on the outer surface of the bony alveolar crest but under the alveolar mucosa/gingivae.

These externally disposed electrodes can match the implant length, can be extended (within the tissue) deeper than the implant or can match a portion of the implant.

For example, the first portion (for example, 2-4 mm) of each externally disposed electrode that is close to the emergence point from the abutment is insulated (preferably of medical grade insulation material). The rest of the electrode can be active (conductive). The conductive part can be made out of a metal such as titanium, platinum, platinum plated titanium, gold and the like. In embodiments the conductive part is coiled or in the form of a mesh or a foil.

This anode configuration allow the current to be evenly distributed in the bony tissue surrounding the implant, avoiding localization of current. The current can be an AC current, a DC current, current pulses or a combination thereof.

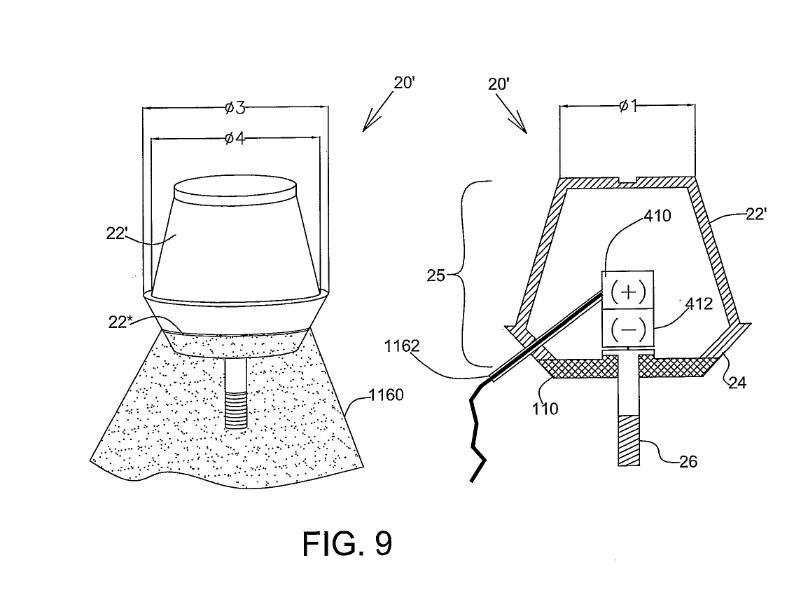

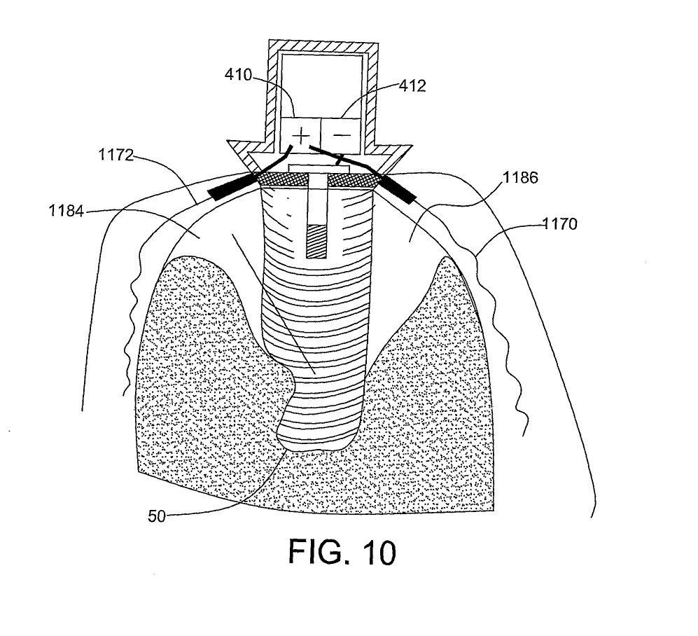

FIG. 9 and FIG. 10 illustrate other embodiments of the invention in which one or more electrodes is shaped as a mesh or as a grid and can assist in guided bone regeneration (GBR).

In many clinical situations implants are implanted into fresh extraction sockets with large bony defects in the implant surrounding, requiring GBR procedures with bone substitute fillers and resorbable or non-resorbable membranes. Such a procedure demands long (4-8 months) healing periods.

A titanium, platinum, platinum plated titanium, gold and the like mesh or grid or foil emerges out of the circumference of the (insulated) abutment at its sub-gingival part and is in the form of a ribbon, apron or umbrella around the implant. It covers the bony deficiency adjacent to the implant site just like a GBR membrane. It sub-gingivally extends along the bony crest outer surface.

The titanium, platinum, platinum plated titanium, gold and the like mesh foil or grid can be easily cut to conform to neighboring implants or teeth.

A titanium or platinum mesh electrode with micro-holes may obviate the need for a membrane.

Leghissa B, Clin Oral Implants Res 1999;10(1):62-8 and Assenza B, J Oral Implantol. 2001;27(6):287-92 have found that titanium mesh or grid as a GBR membrane allowed for new bone formation around implants without a filler. Embodiments of configuration 2 anode accomplish this task much faster with better quality bone.

FIG. 9 depicts abutment 20′ of the present invention having a fixation screw 26 configured to mate with an implant as a cathode, a non-electrode abutment casing top section 22′ and a ring shaped electrode 22*, protruding from the abutment from which a conductive titanium Platinum or other metal mesh or foil 1160 apron hangs, both the mesh and the ring as anodes. The ring can be replaced by one or more point of contact with the apron 1160. The cross sectional view of abutment 20′ illustrates a single point of contact 1162.

FIG. 10 depicts an abutment similar to the abutment depicted in FIG. 6 mated to a prior art conducting titanium implant and disposed so that the titanium Platinum or other metal mesh or foil 1172 and 1170 hangs over, covers and secludes an alveolar bone defect 1184 and 1186.

It is noted that at least one electrode can provide a structural support to bone tissue and can be shaped in different manners such as to include one or more membranes.

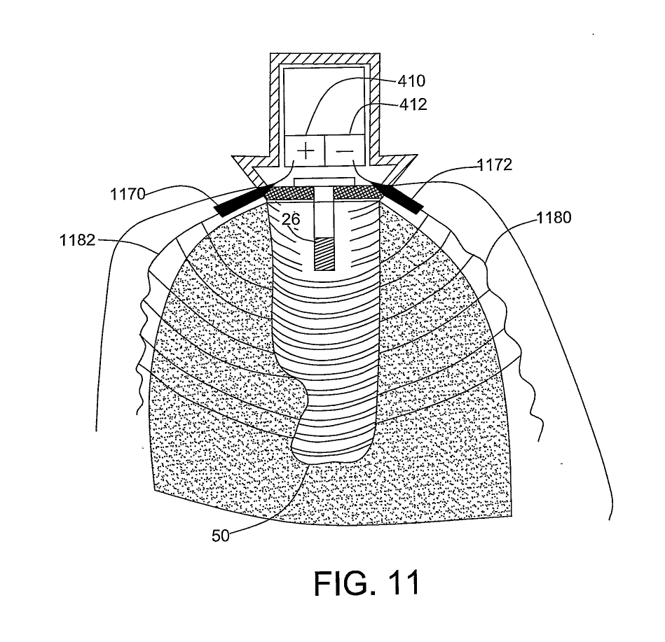

FIG. 11 illustrates that externally disposed electrode 1182 is connected to output port 410 of stimulation mechanism 113 while externally disposed electrode 1182 is connected to output port 412 of stimulation mechanism 113.

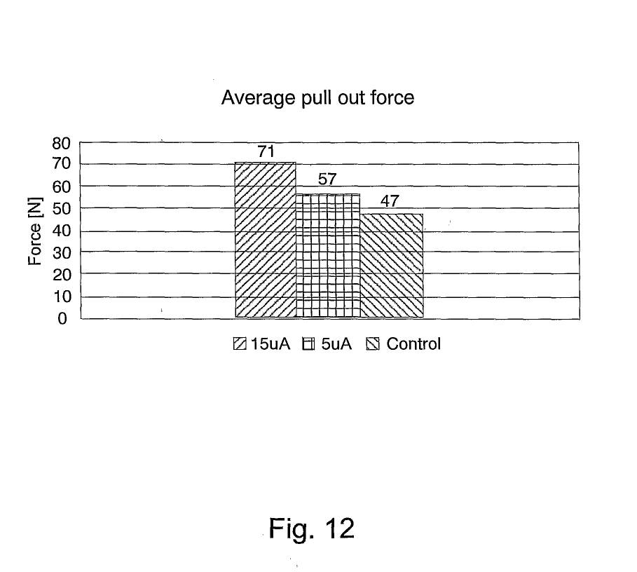

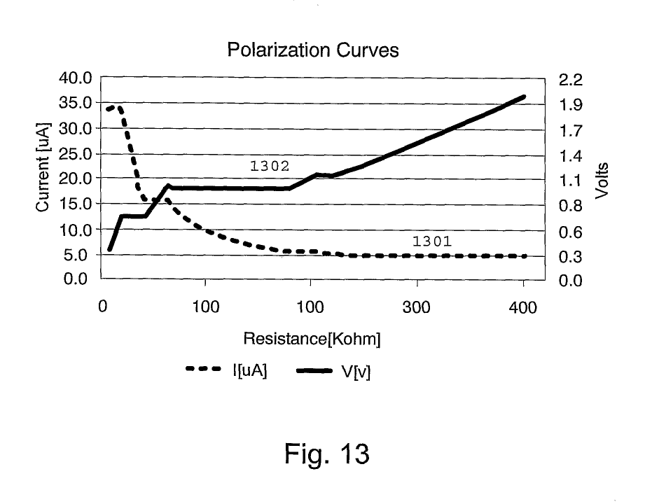

FIG. 12 illustrates a relationship between pull out forces applied on an implanted device versus the currents introduced by the implanted element. FIG. 13 illustrates the required protocol for optimal implant osseintegration acceleration. These figures are explained in further details below.

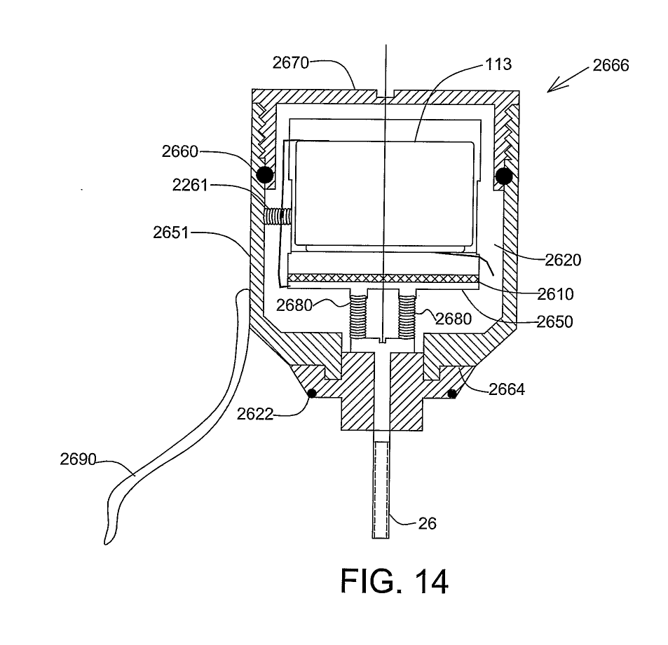

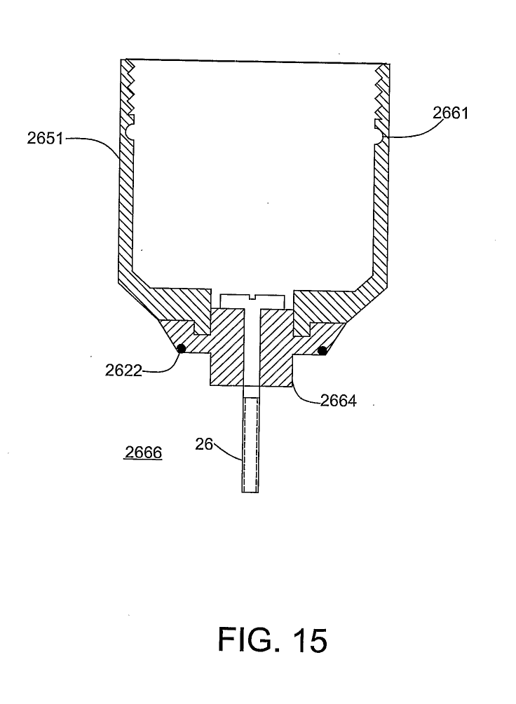

FIG. 14 depicts implant 50 and device 2666. FIG. 15 illustrates device 2666 without removable cover 2670 and without stimulation mechanism 113.

Fixation screw 26 is used to fasten an insulating anti-rotational element 2664 to implant 50. The outer surface of insulating anti-rotational element 2664 prevents it from rotating in relation to the implant and can be oriented in relation to an imaginary vertical axis or otherwise can define a profile that changes along an imaginary vertical axis. It can have a conical shape, include multiple co-centric rings and the like. The insulating anti-rotational element 2664 can include a sealing element (such as o-ring 2662) that prevents liquids from the exterior to penetrate into the interior of 2666

Implant 50 can have conductive elements that can be connected to fixation screw or to an electrode and act as a counter electrode to externally disposed electrode 2690 that is connected to a conductive portion 2651 of the dental abutment Conductive portion 2651 of the abutment has a cylindrical shape and is connected at its top to a removable cover 2670. Conductive portion 2651, removable cover 2670 and insulating anti-rotational element 2664 define a space in which stimulation mechanism 113 is positioned. Stimulation circuit 113 includes printed circuit board (PCB) 2610 and a battery (not shown). Output port 412 (“−”) of PCB 2610 (which is an output port of stimulation mechanism 113) is connected (via conductive springs 2680 to fixation screw 26. Output port 410 (“−”) of PCB 2610 (which is an output port of stimulation mechanism 113) is connected via conductive springs 2662 to conductive portion 2651. Epoxy 2620 can be placed between stimulation mechanism 113, and conductive portion 2651. Sealing element (such as a sealing ring) 2660 can seal the connection between conductive portion 2650 and removable cover 2670. Sealing ring 2660 is placed into recess 2661 of conductive portion 2650. Recess 2661, conductive portion 2651, fixation screw 26 and insulating anti-rotational element 2664 are shown in FIG. 15.

It is noted that one externally disposed electrode can be connected to conductive portion 2651.

It is noted that while the upper portion of the top of fixation screw 26 is contacted by springs 2680 then the lower portion of the top of fixation crew 26 can be in contact one or more sealing elements (not shown) instead of being connected to insulating anti-rotational element 2664. Thus, one or more sealing elements can be located between fixation screw 26 and insulating anti-rotational element 2664.

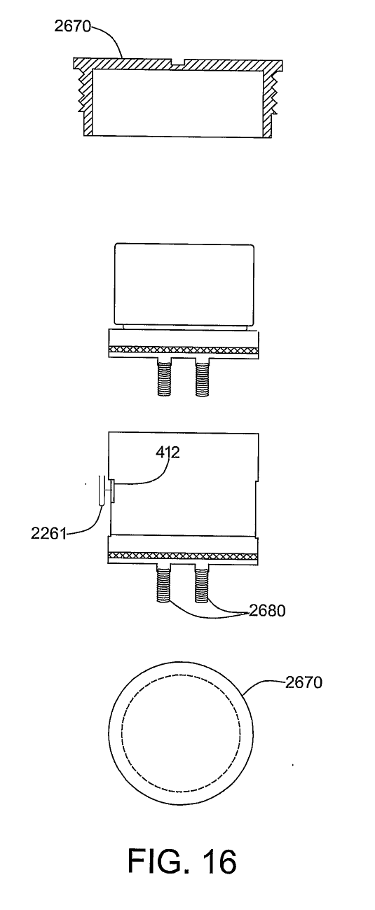

FIG. 16 includes a top view and a cross sectional view of removable cover 2670 and a removable cover view of removable cover 2670. FIG. 16 also illustrates stimulation mechanism 113 as well as some conductive springs such as 2680 and 2261 that connect output ports of stimulation mechanism 113 to other components. Additions due to the results in animal tests

The inventors found that that the DC resistance in an electrolyte increases with time due to the polarization effects by some factor of three. The same resistance defined as the AC resistance is lower by about two orders of magnitude.

Providing simple DC current resulted in large DC resistances rendering a DC current device unpractical—not just due to battery size and life requirements but also due to detrimental impact on the bone formation.

The electrolysis of water begins at minimum 1.2Volts and increases in rate as the voltage is increased. Typically, the electrolysis is carried out around 6 volts.

Cathode: 2H₂O+2e⁻>H₂+2OH⁻

Anode: 2H₂O >O₂+4H⁺+4e⁻

The Hydrogen formation and the associated increase in acidity levels are detrimental to bone formation.

It is therefore desired to maintain the potential below the approximate level of 1.2 Volts. However there is also a need to maintain the initial voltage at implantation time above approximately 0.6 Volts.

This combined effect may be achieved with a nominal current of 15.7 micro Ampere and a combined circuit of DC current followed by a constant voltage when maximal voltage will be achieved due to the expressed resistance changes in vivo. FIG. 13 describes such a current 1301 and potential 1302 relationship. A stimulation mechanism that includes a 1.5 Volt micro battery and microcontroller can maintain the values illustrates in FIG. 13. Immediately post implantation the resistance is low and the optimization can be achieved such as not to be below 0.6 Volts and below 33 microamperes. As the biological resistance increases (over time) the voltage is increased to maintain as long as possible about 15.7 microamperes. Further increment in the biological resistance requires the stimulation mechanism to increase the voltage in order to maintain a current that is not less than 5 microamperes. This situation can be maintained until arriving to a maximal voltage of about more than 1.2 volt. At this point the stimulation mechanism can shut down.

The result is statistically significant faster osseointegration better bone quality due to accelerated bone formation around the implants and prevention of a detrimental environment around the bone. These results are illustrated in FIG. 12 that depicts the statistically significant results achieved in a controlled experiment in rabbits (New Zealand white young-adults about 3 kg in weight). Zimmer standard screw vent implants 3.75 mm diameter were implanted in the condyle of the rabbit femur. For each current regimen there were equal number of active implants and control implants. After two weeks in the animal house the specimens were sacrificed and the force required to pull out each implant was measured in an Instron machine. The results of FIG. 12 indicate that the 15 microamperes regimen yielded forces ˜50% higher than control (no current). The 5 microamperes regimen resulted in only slightly higher forces than the control. A Student-P test indicated that the 15 microamperes results are statistically significant relative to the control and the 5 microamperes results. The 5 microamperes results were not statistically significant relative to the control data.

Provision of an intermittent DC signal In one configuration Hydrogen formation is eliminated (or greatly reduced) by operation around 1.2 Volts, and there is no practical limit to the current applied to the implant bone interface. Such a combination might be possible if the high resistance values in vivo could be reduced.

It is suggested to provide a stimulation circuit that operates with an on-off positive cycle where the frequency will be such as to simulate a typical AC tissue resistance and as a result the overall circuit impedance will be maintained around the AC resistance i.e about 500 Ohms versus tens of Kilo-Ohms to Hundreds of Kilohms (for example −40 to 400 Kilo ohms) in a pure DC configuration.

Such a configuration will enable utilization of very high currents, up to 100 micro Amperes, maintain low potential (well below the 1.2Volts) increase significantly battery life and reduces battery size

According to various embodiments of the invention one or more electrodes do not protrude through a wall or a portion of the dental abutment but rather are connected to a conductive portion of the dental abutment that in turn is connected to a battery or to a stimulation circuit.

According to various embodiments of the invention one or more electrodes protrude through a wall or a portion of the dental abutment but rather are connected to a conductive portion of the dental abutment that in turn is connected to a battery or to a stimulation circuit.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to WO2004/066851 of the inventor.

It is appreciated that certain features of the invention, which are, for clarity, described in the context of separate embodiments, may also be provided in combination in a single embodiment together and together with the teachings of WO2004/066851. Conversely, various features of the invention, which are, for brevity, described in the context of a single embodiment, may also be provided separately or in any suitable sub combination. Although the invention has been described in conjunction with specific embodiments thereof, it is evident that many alternatives, modifications and variations will be apparent to those skilled in the art. Accordingly, the present invention is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In case of conflict, the specification herein, including definitions, prevails. Citation or identification of any reference in this application shall not be construed as an admission that such reference is available as prior art to the present invention.

1. A disposable osteogenesis and osseointegration promotion and maintenance device, comprising:
a dental abutment;
a stimulation circuit positioned within a space defined at least partially by the dental abutment; and
at least one externally disposed electrode that is spaced apart from a dental implant that is connected to the dental abutment;
wherein each externally disposed electrode is connected to an electrical component selected from a group consisting of a battery and a stimulation circuit.

2. The device according to claim 1 wherein the at least one externally disposed electrode is coupled to the dental abutment.

3. The device of claim 1 wherein the stimulation can be performed whether the device is above, at and sub gingival level.

4. The device according to claim 1 wherein the at least one externally disposed electrode protrudes from the dental abutment.

5. The device according to claim 1 wherein when at least one externally disposed electrode protrudes from the abutment at a sub-gingival portion of the dental abutment.

6. The device according to claim 1 wherein an externally disposed electrode is shaped so that when the device is implanted in osseous tissue the externally disposed electrode extends under the alveolar mucosa/gingivea.

7. The device according to claim 1 wherein an externally disposed electrode is insulated from an outer surface of dental abutment portion from which it protrudes.

8. The device according to claim 1 wherein an externally disposed electrode is shaped as a mesh; wherein an externally disposed electrode is shaped as a mesh that at least partially surrounds an upper portion (circumference) of the implant; wherein an externally disposed electrode is placed, when the device in implanted, so as to cover a bony deficiency adjacent to the implant site.

9. (canceled)

10. The device according to claim 1 wherein the at least one externally disposed electrode is shaped so to provide an evenly distributed current through a tissue that surrounds the implant.

11. (canceled)

12. (canceled)

13. (canceled)

14. (canceled)

15. (canceled)

16. The device according to claim 1 wherein an externally disposed electrode provides a structural support for directing growth of bone tissue and has a shape selected form the group consisting of a sheet, a foil, a mesh, a net, a strip, a grid, a ribbon, an umbrella, a tissue, a screen, a fabric, a woven fabric and netting.

17. The device according to claim 1 wherein the at least one externally disposed electrode comprises an externally disposed anode and an externally disposed anode.

18. (canceled)

19. The device according to claim 1 wherein a conductive securing element of the dental abutment that is connected to the implant acts as a counter electrode to an externally disposed electrode and wherein the conductive securing element is electrically connected to conductive elements that pass trough the implant.

20. The device according to claim 1 wherein a conductive securing element of the dental abutment that is connected to the implant acts as a counter electrode to an externally disposed electrode and wherein the conductive securing element is electrically connected to at least one ring shaped conductor located at an outer surface of the implant.

21. (canceled)

22. (canceled)

23. The device according to claim 1 comprising a replaceable battery; wherein the dental abutment is shaped to enable a replacement of the replaceable battery.

24. The device according to claim 1 comprising a replaceable battery; wherein the dental abutment comprises a movable portion that when placed at a first position enables a replacement of the replaceable battery.

25. (canceled)

26. The device according claim 1 wherein the stimulation circuit generates an electrical signal that maintains a potential between an externally disposed electrode and a counter electrode below 1.9 volts.

27. (canceled)

28. (canceled)

29. (canceled)

30. (canceled)

31. (canceled)

32. (canceled)

33. (canceled)

34. (canceled)

35. The device according to claim 1 wherein the stimulation circuit generates an alternating electrical signal that has a cycle that substantially eliminates increase of resistance in tissue that is proximate to the implant.

36. (canceled)

37. The device according to claim 1 wherein the stimulation circuit generates an electrical signal that alternates between a “on” value and an “off” value at a cycle that eliminates an increment of electrolysis of fluid at a vicinity of the implant.

38. (canceled)

39. (canceled)

40. (canceled)

41. The device according to claim 1 wherein at least a portion of a surface of the dental abutment is electrically conductive and in electrical contact with an externally disposed electrode.

42. The device according to claim 1 wherein at least a portion of a surface of the dental abutment is electrically insulated form an externally disposed electrode.

43. (canceled)

44. (canceled)

45. (canceled)

46. (canceled)

47. The device according to claim 1 wherein an externally disposed electrode comprises a stem part emerging from said abutment; and wherein an outer portion of the stem part is externally insulated.

48. (canceled)

49. (canceled)

50. (canceled)

51. (canceled)

52. (canceled)

53. (canceled)

54. (canceled)

55. The device according to claim 1 comprising a native anti-rotation element.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)
